(19) United States
(12) Patent Application Publication
(10) Pub. No.: US 2008/0091551 A1
(43) Pub. Date: Apr. 17, 2008

(54) Knowledge-based customizable product design system

(76) Inventors: Marvin Olheiser, Ocala, FL (US); Edward Laiz, Ocala, FL (US); Larry Schenavar, Ocala, FL (US)

Correspondence Address: MERCHANT & GOULD PC, P.O. BOX 2903, MINNEAPOLIS, MN, 55402-0903, US

(21) Appl. No.: 11/540,845

(22) Filed: Sep. 29, 2006

(51) Int. Cl. G06Q 30/00

(52) U.S. Cl. 705/26

(57) ABSTRACT

Methods of requesting and designing a customizable product are disclosed. One method includes associating a plurality of graphical objects with the plurality of sales codes. The method also includes receiving one or more sales codes. The method includes selecting one or more graphical objects associated with the one or more sales codes. The method further includes applying one or more design rules to the one or more graphical objects to generate a proposed design drawing.

### TECHNICAL FIELD

The present invention relates generally to product design. The present invention more specifically relates to knowledge-based design of customizable products.

### BACKGROUND

Purchasers of various types of high-cost or high-volume products often want to be able to customize such products prior to purchase. Often, such purchases include a request for proposal process in which a prospective purchaser requests a price quotation and design proposal for a product, and decides whether or not to purchase a product from a supplier based on the extent to which the price and design matches the prospective purchaser's goals.

Products sold using this request process, referred to herein as customizable products, are distinguishable from premanufactured products produced in a number of preconfigured permutations, in that customizable products are generally not manufactured prior to a specific request or order by a purchaser. Although some of these products can also be manufactured as non-customizable products, customizable products can include a wide variety of manufactured products, including vehicles, such as cars or utility vehicles, houses, machine parts, or other products.

FIG. 1 illustrates a possible existing process through which customizable products are ordered and purchased in the context of a fire department requesting a proposed design for manufacture of a new fire truck or other fire-fighting equipment. Referring generally to FIG. 1, a municipality or fire department works with a dealer to provide the dealer with various specifications for the desired fire truck. The dealer submits the request for drawings and a price quotation to a design team.

The design team receives specifications from the dealer and works to produce a price quotation and bid, as well as proposed design drawings reflecting the proposed design. The design team works to meet both the criteria set by the potential purchaser in the request, and also works to meet external design requirements. External design requirements can include additional design requirements known by the design team, such as particular designs that have worked well or worked badly in the past, or environmental or regulatory requirements necessitated by the customer, a governmental entity, or other entity. This design process incorporates the knowledge of the designers to create a product proposal, but in doing so requires a large amount of labor-intensive design work.

Following the quotation and drawing creation phases, a full engineering review is performed, which requires a number of individuals and many man-hours from each individual to ensure that the proposed design is feasible, i.e. fits within the generalized parameters for the project, and also meets the criteria set by the potential purchaser in the request. The engineering review performs an iterative process by which an engineering team modifies the quotation and drawings, and works with the dealer in order to ensure that the design meets the potential purchaser's requirements as well any additional applicable requirements. Once drawings are approved, final quotations and designs are prepared and provided to the potential purchaser.

The design process described above can require a large number of man-hours to prepare a design for a customer. In the example of the fire truck, a number of man-weeks of work are required for each design and quote. Further, the individuals involved in the design may not design a system according to the potential purchaser's request or may overlook various design details, which would extend the engineering review phase as additional or more extensive design modifications would need to be made. Additional information may need to be requested from a dealer if not all required information is initially submitted by the dealer working with the potential purchaser. Furthermore, sales of customizable products may be lost based on the large lag time between the request and the responsive design proposal.

Therefore, improvements are desired.

### SUMMARY

The above and other problems are solved by the following:

According to a first aspect, a computer implemented method of designing a customizable product is disclosed. The method includes associating a plurality of graphical objects with the plurality of sales codes. The method also includes receiving one or more sales codes. The method includes selecting one or more graphical objects associated with the one or more sales codes. The method further includes applying one or more design rules to the one or more graphical objects to generate a proposed design drawing.

In a second aspect, a computerized system for design of customizable products is disclosed. The system includes a memory configured to store a plurality of sales codes and a plurality of graphical objects associated with the plurality of sales codes. The system also includes a programmable circuit interfaced with the memory. The programmable circuit is programmed to associate a plurality of graphical objects with the plurality of sales codes. The programmable circuit is also programmed to receive one or more sales codes. The programmable circuit is further programmed to select one or more graphical objects associated with the one or more sales codes. The programmable circuit is programmed to apply one or more design rules to the one or more graphical objects to generate a proposed design drawing.

In a third aspect, a method of requesting a design of a customizable product is disclosed. The method includes displaying a user interface presenting a plurality of sales options associated with a plurality of sales codes. The method also includes accepting user selection of one or more sales options from the plurality of sales options. The method also includes transmitting one or more sales codes associated with the one or more sales options. The method includes displaying a proposed design drawing of the customizable product, the drawing incorporating one or more graphical objects associated with the one or more sales codes, wherein one or more design rules applied to the graphical objects form the proposed design drawing.

### BRIEF DESCRIPTION OF THE DRAWINGS

FIG. 1 is a block diagram of a prior art price quotation and design process;

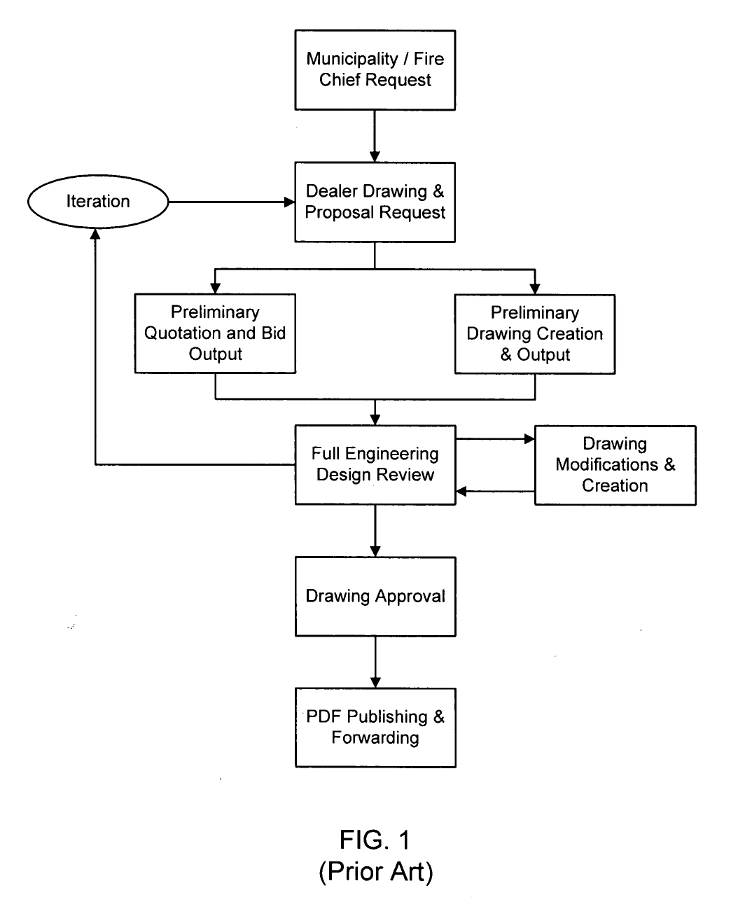

FIG. 2 is a block diagram of methods and systems for design of a customizable product according to a possible embodiment of the present disclosure;

FIG. 3 is a schematic representation of an exemplary network system useable by a customer to request a price and drawing quotation for a customizable product;

FIG. 4 is a schematic representation of a computing system that may be used to implement aspects of the present disclosure;

FIG. 5 is a block diagram of a system for price quotation and design according to a possible embodiment of the present disclosure;

FIG. 6 is a block diagram of methods and systems for design of a customizable product according to a possible embodiment of the present disclosure;

FIG. 7 is a block diagram of methods and systems for requesting a design of a customizable product according to a possible embodiment of the present disclosure;

FIG. 8 shows an exemplary user interface for design of a fire truck associating sales codes to graphical objects and defining design rules according to a possible embodiment of the present disclosure;

FIG. 9 shows an exemplary user interface for design of a fire truck defining fire truck body graphical objects and design rules according to a possible embodiment of the present disclosure;

FIG. 10 shows an exemplary user interface for design of a fire truck defining fire truck compartment graphical objects and design rules according to a possible embodiment of the present disclosure;

FIG. 11 shows an exemplary user interface for design of a fire truck defining groupings of fire truck graphical objects according to a possible embodiment of the present disclosure;

FIG. 12 shows an exemplary user interface for design of a fire truck defining reference point design rules according to a possible embodiment of the present disclosure;

FIG. 13 shows an exemplary user interface for design of a fire truck defining attributes of graphical objects according to a possible embodiment of the present disclosure;

FIG. 14 shows an exemplary user interface for design of a fire truck displaying an overall drawing plan according to a possible embodiment of the present disclosure;

FIG. 15 shows an exemplary user interface for receiving a request for a proposed design according to a possible embodiment of the present disclosure;

FIG. 16 shows an exemplary user interface for viewing and downloading a proposed design drawing according to a possible embodiment of the present disclosure; and

FIG. 17 is an example proposed design drawing of a fire truck generated according to the principles of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the invention described herein are implemented as: (1) a sequence of computer implemented steps, operations, or procedures running on a programmable circuit within a computer, (2) a sequence of computer implemented steps, operations, or procedures running on a programmable circuit; and/or (3) interconnected machine modules or program engines within the programmable circuits.

In general, the present disclosure relates to design of customizable products. Certain parameters are selected. Objects are associated with the parameters, such that selection of the certain parameters causes the associated objects to be called. Design rules are then applied to the associated objects to create a design. Typically, the design rules are knowledge-based and apply certain rules to the creation of the design.

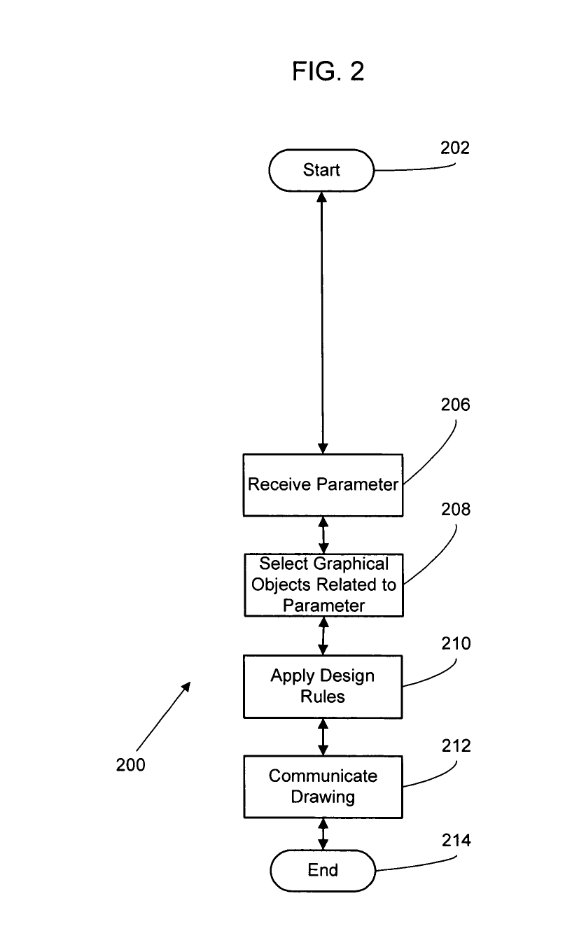

Referring now to FIG. 2, a block diagram of methods and systems 200 for design of a customizable product is shown according to a possible embodiment of the present disclosure. Operational flow of the system 200 begins at a start operation 202. Operational flow proceeds to a receive operation 206. The receive operation 206 receives sales codes related to requested features desired by a potential purchaser of the customizable product. By the term “sales codes” or “parameters” herein, it is meant sales codes, option identifiers, top level bill of material assembly numbers, or parameters. The requested features are a subset of those features for which sales codes are assigned and design options are available. A design option refers to the choice between the presence or absence of various features of the customizable product, or selection among a group of inconsistent features. For example, in fire truck design, cab capacity would be considered a design option for which a fire truck would have at least two configurations available (i.e. single row or two row seating).

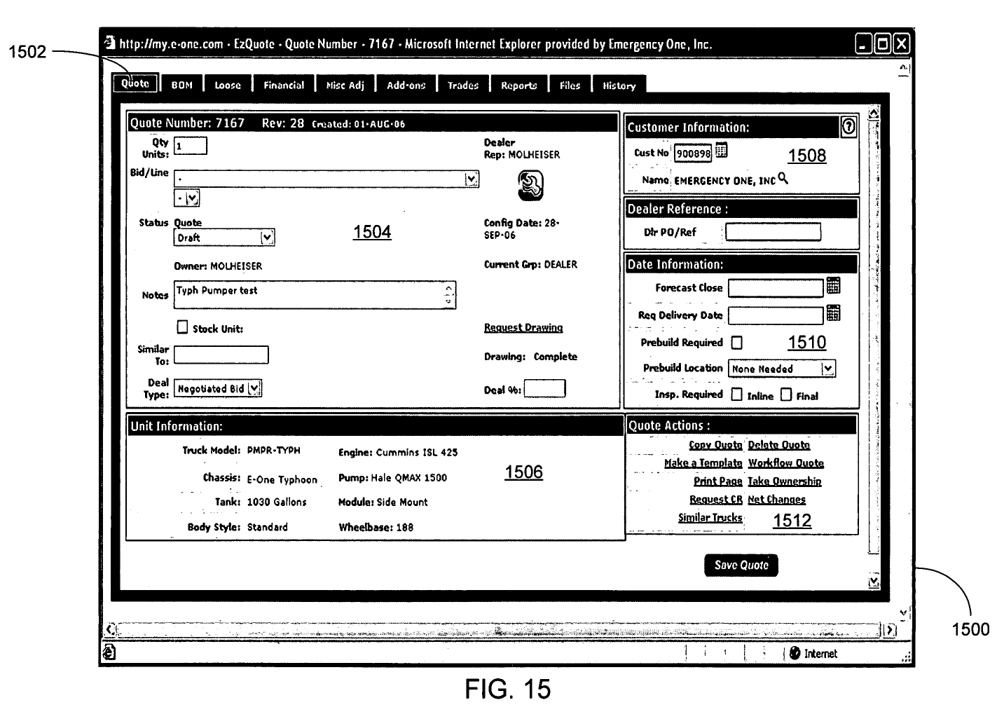

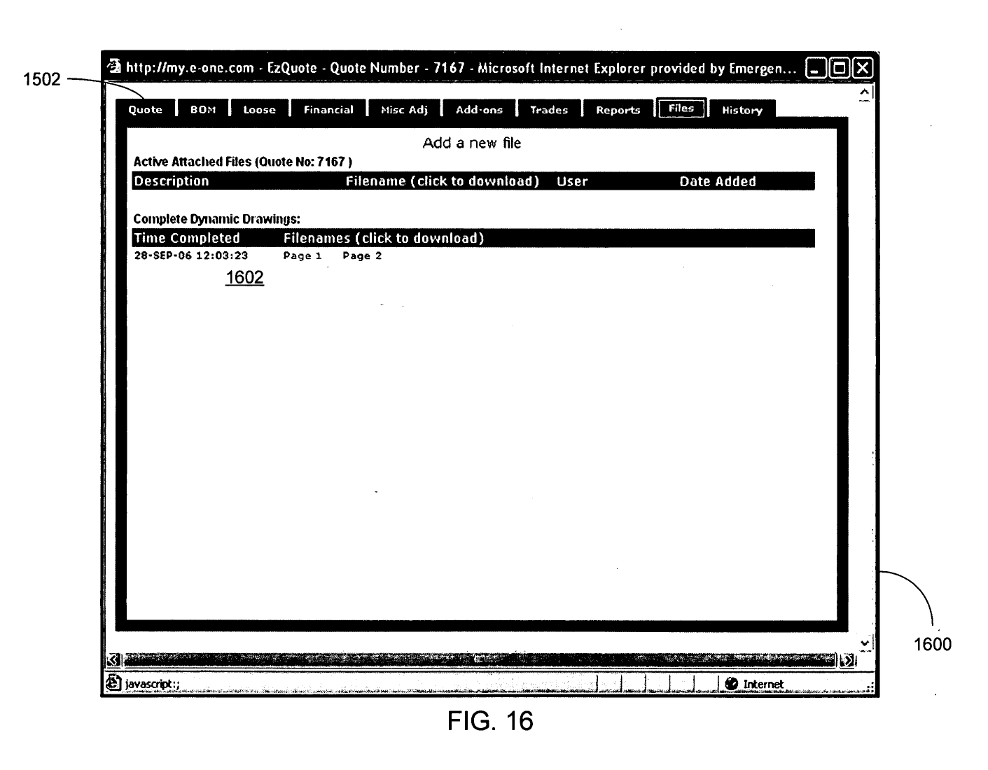

Preferably, the receive operation 206 receives the sales codes from a web utility, such as a web portal or other generalized user interface. The web portal can present the prospective purchaser or a dealer with one or more screens in which the user of the web portal can choose one or more design options. An example user interface is described below in conjunction with FIGS. 15-16.

A select operation 208 selects or accesses graphical objects associated with, or related to, the sales codes. Graphical objects refer to stored drawings or portions of drawings that relate to the specific physical object to be represented. For example, a graphical object of a portion of a fire truck, such as the cab portion, is stored as a self-contained module. A second cab portion can be stored as well, where the two cab portions are distinguishable based on a customizable characteristic (e.g. 2 door cab or 4 door cab).

In another possible embodiment, a graphical object is data, such as a set of coordinates in a computer-aided drawing program, such as AutoCAD or other system, which in turn creates a drawing of a customizable product or a portion thereof. Preferably, sales codes refer to identifiers related to specific identifying or customizable features of a customizable product that would distinguish that product from other products and/or other permutations of the same customizable product. The graphical objects relate to the sales codes in that the sales code representing a specific selectable feature of the customizable product corresponds to a graphical object displaying that feature.

In an example of a fire truck customized for a particular municipality, a sales code corresponding to a truck capable of carrying four individuals within the cab portion of the truck corresponds to a graphical object of a seating portion of a fire truck having two rows of seats and an extended cab portion. A sales code corresponding to a truck capable of carrying two individuals within the cab portion of the truck corresponds to a graphical object of a seating portion of a fire truck having a single row of seats and a non-extended cab portion. By selecting one of the sales codes, the corresponding graphical object is selected as well.

The select operation 208 loads the graphical objects in preparation for processing in a design rules operation 210. In a possible embodiment, the system 200 includes default graphical objects to be used for a customizable product for which no design option is selected and no sales code is provided. In a second possible embodiment, the user interface is configured to produce sales codes for the system 200 regardless of whether all design options are selected by generating default sales codes. In a third possible embodiment, if particular options are not selected and no sales code is provided, an alert can be generated to the user that such information is required.

The design rules operation 210 applies one or more design rules configured to accommodate the sales codes received by the system 200. Preferably design rules refer to computer-implemented rules defined in the system 200 that are used to form a customized product. Typically, the design rules are knowledge-based rules and indicate how the graphical objects interrelate, and can act as a restraint upon specific configurations of graphical objects such that a practical design of the customizable product is accomplished via an at least partly computerized process. The design rules operation 210 applies the design rules to the graphical objects determined using the receive module 208. The design rules module 210 thereby creates a proposed design drawing for the customizable product that integrates the design options desired, by translating the design options into sales codes, the sales codes into graphical objects, and using design rules to form a coherent whole from the graphical objects selected.

A wide variety of design rules can be used, and can relate to a variety of best practices known by the designers of the customized product. These best practices correspond to the design rules applied in the design rules operation 210. The design rules therefore provide a knowledge-based system for accomplishing a large portion of the initial design process.

In an example implementation of a design rules operation 210 used to create a proposed design drawing of a fire truck, a design rule may be related to an optimal turn radius for the fire truck for it to be useable on residential streets. Options affecting the turn radius, such as the wheelbase length, may be changed due to a customizable option such as ladder length, water tank size, or other parameters, but not to the extent that the turn radius requirement is compromised.

Operational flow proceeds to a communicate operation 212. The communicate operation 212 communicates a drawing created in the design rules module 210. The drawing is a proposed design drawing of the customizable object, and reflects the design options selected by a user of the system 200. In one embodiment, the communicate operation 212 transmits the proposed design drawing to a remote computer, where it can be accessed by a user of the system such as a dealer or a prospective purchaser. In a further embodiment, the communication module 212 causes the proposed design drawing to be displayed locally for further review by design and/or validation by a design or engineering group.

Operational flow terminates at an end operation 214.

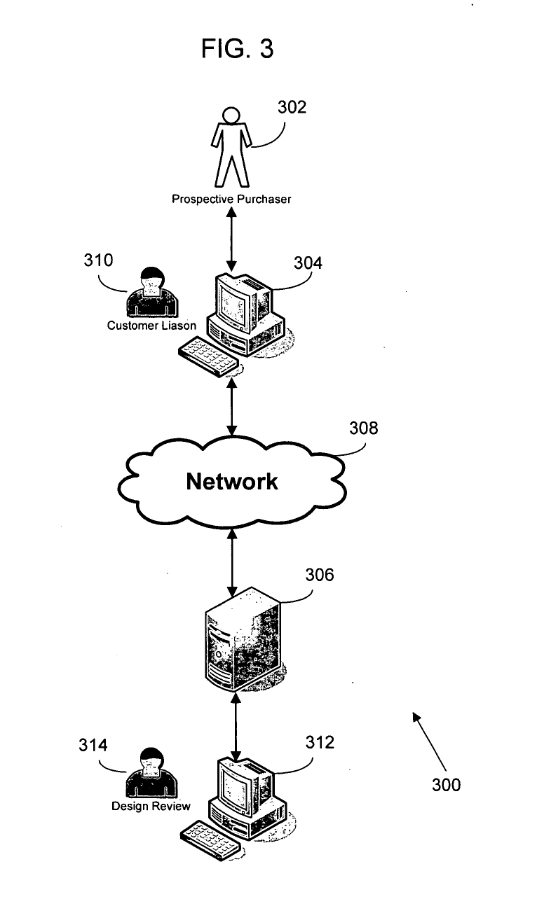

Referring now to FIG. 3, a schematic representation of an exemplary network system useable by an end-user, or customer, to request a customizable product is shown. Preferably, the network system 300 interfaces with a prospective purchaser 302, such as a private or governmental individual or entity. In one possible embodiment, the prospective purchaser 302 is a fire department or related municipal entity. The prospective purchaser 302 defines the design options by using a computing system 304 interfaced to a server 306 via a network 308. Optionally, a customer liaison 310, such as a dealer for the customizable product, assists the prospective purchaser by receiving design requirements from the user and entering the user information into the computing system 304. The computing system 304 can be a thin client system, a kiosk-type system, or a “thick” personal computing system capable of hosting one or more applications. Such systems are known to those of ordinary skill in the art.

Preferably, the server 306 is a file/database server, and can optionally be configured to act as a web content server as well, such that the user interface is hosted from the server 306 to a client system, such as the computing system 304. The server 306 also stores a plurality of design rules, graphical objects, and sales codes, as described above. In a possible embodiment, the server 306 is a web and database server configured using a web-enabled database management system to present a user interface to a browser displayed on a display of a client computing system, such as the computing system 304. In one embodiment, the user interface is a web portal. In a further embodiment, the user interface resides on the computing system 304 and data is shared across the network 308.

The network 308 linking the server 306 and computing system 304 can be any communications link or a number of internet, WAN, LAN, or other types of TCP/IP or other networking protocols configured to provide a communication link between the systems.

Optionally, one or more computing systems 312 link to the server 306 via some type of network or communication link. An individual or team of individuals assigned to design overview 314 can use these computing systems to test and/or validate the design of the customizable product.

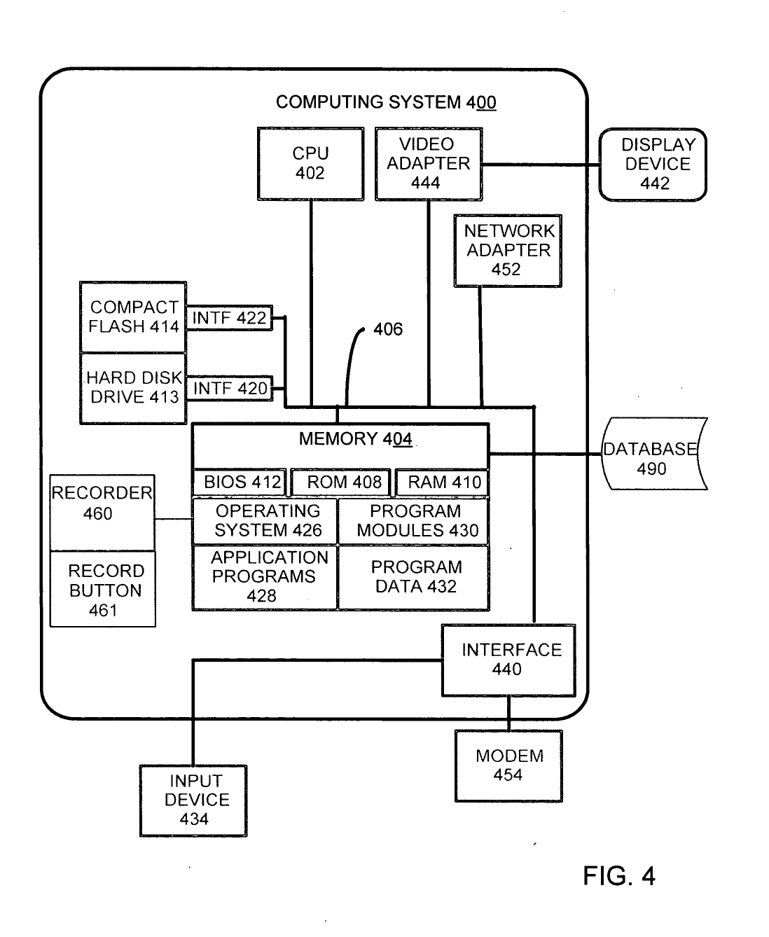

FIG. 4 illustrates an exemplary architecture for a computing system that can be used to implement aspects of the present disclosure, such as the computing systems 304, 312 or the server 306 of FIG. 3. The computing system architecture includes a general purpose computing device in the form of a computing system 400. The computing system 400 can be used, for example, as the computing system or server of FIG. 2, and can execute program modules included in the administrative software or user software disclosed below.

The computing system 400 including at least one processing system 402. A variety of processing units are available from a variety of manufacturers, for example, Intel or Advanced Micro Devices. The computing system 400 also includes a system memory 404, and a system bus 406 that couples various system components including the system memory 404 to the processing unit 402. The system bus 406 may be any of a number of types of bus structures including a memory bus, or memory controller; a peripheral bus; and a local bus using any of a variety of bus architectures.

The system memory 404 can include read only memory (ROM) 408 and random access memory (RAM) 410. A basic input/output system 412 (BIOS), containing the basic routines that help transfer information between elements within the computing system 400, such as during start up, is typically stored in the ROM 408.

The computing system 400 can also include a secondary storage device 413, such as a hard disk drive, for reading from and writing to a hard disk (not shown), and/or a compact flash card 414.

The hard disk drive 413 and compact flash card 414 are connected to the system bus 406 by a hard disk drive interface 420 and a compact flash card interface 422, respectively. The drives and cards and their associated computer readable media provide nonvolatile storage of computer readable instructions, data structures, program modules and other data for the computing system 400.

Although the exemplary environment described herein employs a hard disk drive 413 and a compact flash card 414, other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), or read only memories (ROMs).

A number of program modules may be stored on the hard disk 413, compact flash card 414, ROM 408, or RAM 410, including an operating system 426, one or more application programs 428, other program modules 430, and program data 432. A user may enter commands and information into the computing system 400 through an input device 434. Examples of input devices might include a keyboard, mouse, microphone, joystick, game pad, satellite dish, scanner, digital camera, touch screen, and a telephone. These and other input devices are often connected to the processing unit 402 through an interface 440 that is coupled to the system bus 406. These input devices also might be connected by any number of interfaces, such as a parallel port, serial port, game port, or a universal serial bus (USB). Wireless communication between input devices and interfaces 440 is possible as well, and can include infrared, bluetooth, 802.11a/b/g, cellular, or other radio frequency communication systems. A display device 442, such as a monitor or touch screen LCD panel, is also connected to the system bus 406 via an interface, such as a video adapter 444. The display device 442 might be internal or external. In addition to the display device 442, computing systems, in general, typically include other peripheral devices (not shown), such as speakers, printers, and palm devices.

When used in a LAN networking environment, the computing system 400 is connected to the local network through a network interface or adapter 452. When used in a WAN networking environment, such as the Internet, the computing system 400 typically includes a modem 454 or other communications type, such as a direct connection, for establishing communications over the wide area network. The modem 454, which can be internal or external, is connected to the system bus 406 via the interface 440. In a networked environment, program modules depicted relative to the computing system 400, or portions thereof, may be stored in a remote memory storage device. It will be appreciated that the network connections shown are exemplary and other methods of establishing a communications link between the computing systems may be used.

The computing system 400 might also include a recorder 460 connected to the memory 404. The recorder 460 includes a microphone for receiving sound input and is in communication with the memory 404 for buffering and storing the sound input. The recorder 460 also can include a record button 461 for activating the microphone and communicating the sound input to the memory 404.

A computing device, such as computing system 400, typically includes at least some form of computer-readable media. Computer readable media can be any available media that can be accessed by the computing system 400. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 400.

Communication media typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

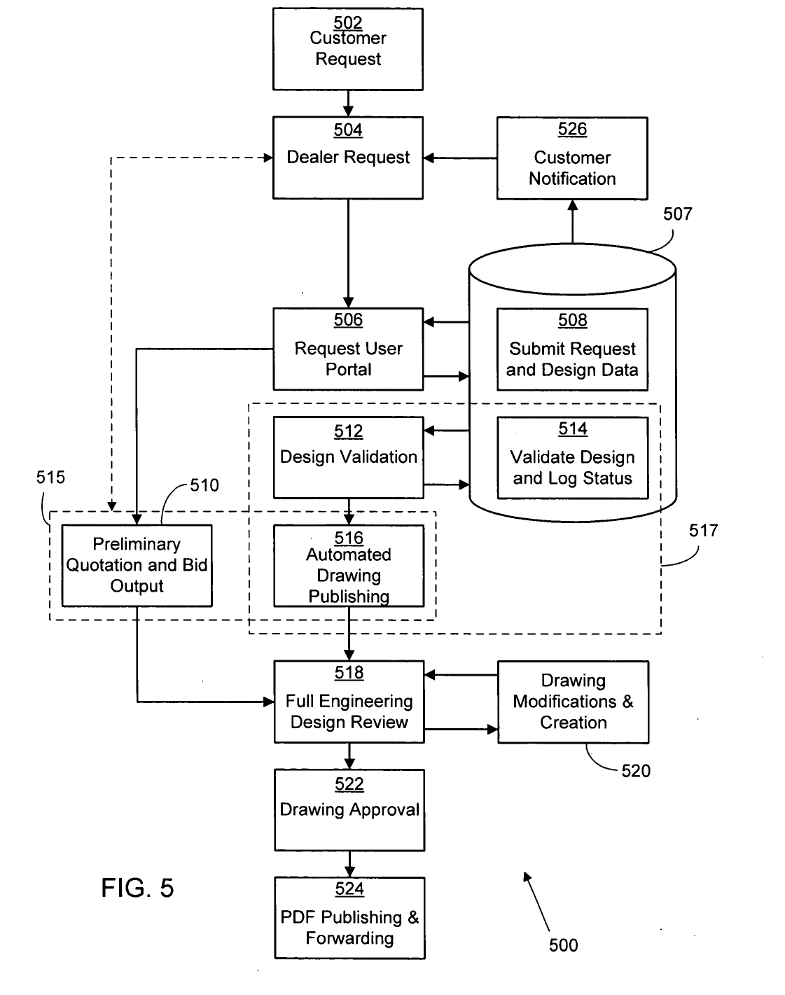

FIG. 5 displays a block diagram of a system 500 for price quotation and design according to a possible embodiment of the present disclosure. The system 500 generally provides a logical structure by which design of a customizable product takes place. The system 500 can operate across the system 300 of FIG. 3, although additional or alternate configurations can also be used.

The system 500 includes a customer request operation 502. The customer request operation 502 represents the interaction between the prospective purchaser 302 and the computing system 304 of FIG. 3, optionally including customer liaison 310. A prospective purchaser communicates with the customer liaison, such as a dealer of the customizable product, who in turn operates the user interface. A dealer request operation 504 represents the dealer or other customer liaison receiving instructions, or requests, from the customer, such as design option preferences or other cost/design parameters, and forming a request for a design drawing and price quotation.

The user interface, or portal, presented to the customer 302 or customer liaison 310 allows for entry of the customer request into the computing system 304 of FIG. 3. The portal can be an application based portal residing on the computing system and sharing data with the server 306 of FIG. 3. Alternately, the user interface can be a web-based user interface configured to display design options to the user of the portal via a web browser, such as Microsoft Internet Explorer, Mozilla Firefox, Opera, or other web browsing software. In one implementation of a web portal, the user interface is an ASP web client.

Request and design data received from the customer 302 or customer liaison 310 is converted into sales data and shared with an automated drawing module 506 and an output module 510. Sales data refers to one or more sales codes corresponding to the design options selected using the portal. The output module 510 provides a final proposed design drawing to the user.

The automated drawing module 506 and output module 510 both interface with a design database 507. The database can be any of a number of commercially available databases, and in one possible embodiment is a SQL relational database management system (DBMS). In one implementation, an Oracle SQL database is used, and VB.NET programming provides a common communication language between the user interface and the design database 507. Preferably, the design database 507 contains defined sales codes, design options, and correlations to graphical objects related to the customized product.

The user interface, or portal, presents design options to the user to form a customized product. The portal submits to the automated drawing module 506 and the output module 510 the user's selected design options. The portal can be configured to require a full set of design options, such that the set of design options defines a possible layout of a customized product. If a customized product cannot be defined based on the design options selected, the portal optionally displays a form to prompt the user to select the remaining design options necessary to define the customized product. In an alternative embodiment, the system 500 assigns default design options for each of the unselected design options.

The automated drawing module 506 generates a drawing based on the sales data provided via the portal. The automated drawing module 506 receives the sales data entered into the user interface and correlates the sales data to graphical objects stored in a drawing block library 512. The correlation information can be located within the automated drawing module 506, design database 507, or drawing block library 512. The automated drawing module 506 selects one or more graphical objects and places the graphical objects in appropriate locations in a proposed design drawing. The automated drawing module 506 applies design rules to the graphical objects to form a proposed design drawing based on requested parameters. The design rules define which graphical objects are used, and how the graphical objects are formed into the proposed design drawing.

In a possible embodiment, the graphical objects stored in the drawing block library 512 include pre-designed graphical features. In a further possible embodiment, the graphical objects include pre-programmed routines which define a method by which the graphical objects are drawn. In one embodiment, the graphical objects are stored in the drawing block library 512 as AutoCAD formatted drawings, and are configured for editing by AutoCAD software resident on the server 306 of FIG. 3.

Preferably, the design options selected using the portal correlate to sales codes, which in turn correlate to graphical objects stored in the drawing block library 512, as described above, such as via tables in a relational database accessed by the automated drawing module 506. For example, a schema containing a table of sales codes could reference a fact table containing graphical objects. In another example, the sales codes are stored separately in the design database and accessed by the automated drawing module 506 for correlation to graphical objects stored in the drawing block library 512. Other configurations or methodologies for storing design rules and correlations could be used as well. The system 500 is configured to apply design rules to the graphical object to form a design based on requested parameters. The proposed design drawing can be, for example, a collection of preferences embodied as graphical objects. In a possible embodiment, the design database 507 or automated drawing module 506 resident upon the server 306 of FIG. 3 triggers the design process. In a further possible embodiment, the design process is triggered externally to the server.

Preferably, the output operation 510 stores the graphical objects and associated information stored in the design database 507 for retrieval by a customer or dealer via the portal. In another possible embodiment, the output operation 510 stores the graphical objects in an external memory to the design database 507, such as in the server 306 or a computing system 304, 312. The associated information includes, for example, parts lists required for the physical product associated with the graphical object, prices for parts, and design layout information.

The system 500 optionally validates the proposed design as well. The system 500 automates application of one or more design rules to it to verify that the design is technically feasible. By technically feasible, it is intended that the design meet the criteria set by the prospective purchaser in the customer request operation 502, while also meeting environmental, regulatory, and other physical constraints. The system 500 passes or fails the generated design. A log within the design database 507 stores data regarding the design validation process, such as steps taken to validate the design, rules applied, and outcome (i.e. pass or failure of the design according to one or more design rules). The system 500 therefore ensures that the output operation 510 and automated drawing creation module 506 provide a validated design that corresponds to the price and part quotation output from the output operation 510 and proposed design drawing from the automated drawing creation module 506.

A notification operation 526 notifies the prospective purchaser that the proposed design drawing and price quotation are prepared and can be viewed. In one embodiment, the notification operation 526 transmits the proposed design drawing and price quotation to the user directly. In a second embodiment, the proposed design drawing and price quotation return to the portal for viewing by the dealer and/or prospective purchaser. In a third embodiment, the proposed design drawing and price quotation are stored on a server for retrieval by the user, such as in design database 507. In an alternate embodiment, the notification module notifies a user about additional information needed by the design database 507 as necessary to form the proposed design, above.

The dealer or other portal user can use the portal to iteratively change design parameters and receive proposed design drawings and price quotations without requiring interaction from a design engineer. When the dealer or customer arrives at a combination of design options which correspond to a proposed design and price quotation acceptable to the customer, the customer or dealer can approve the design in the portal.

Once the proposed design is approved, a design review operation 518 is instantiated. The design review operation 518 represents a number of resources used to fully validate the design generated using the portal, database, design options, sales codes, graphical objects, and design rules. In one embodiment, a design review team comprised of engineers and other designers review the computer-generated proposed design drawing and price quotation for accuracy and completeness. A modification operation 520 represents modification work required based on missing or invalid sales codes as generated using the automated process. In a possible embodiment, the drawing modifications during the design review correspond to modification of the graphical objects, sales codes, or design rules such that future proposed design drawings and price quotations do not require the same changes. For example, additional design rules are created by the design review team such that design review needs decrease with use of the system 500. In one embodiment, the design review operation 518 and the modification operation 520 operate iteratively, in that the modified drawing then receives full design review in the design review operation 518.

An approval operation 522 represents final approval of the design following a full design review. In one embodiment the approval operation 522 indicates that one or more individuals have approved the design. The individuals can be, for example, engineers, designers, customers, or dealers. In a further embodiment, the approval module 522 indicates that a computerized validation process has successfully tested the design following the full design review.

A publishing operation 524 compiles the approved design drawing, and optionally also compiles a price quotation. The publishing operation 524 prepares the design drawing for viewing by the dealer and/or prospective purchaser, and for transmission to a user via a network or to the user portal. In a possible embodiment, the publishing operation 524 prepares a document in PDF format (Portable Document Format, by Adobe Systems, Inc.) incorporating the approved design drawing and/or the quotation. Other document formats can be used as well. In a possible embodiment, the format of the document provided to the user is an option presented to the user in the user portal, and the document is formatted accordingly prior to transmission to the user.

The design database 507 optionally also stores information related to the rate at which a prospective purchaser accepts the bid and proposed design. This information, referred to herein as the success rate of the system, can include information related to the number of proposals generated, the number of proposals generated for a particular purchaser, the size or cost of the order accepted and/or rejected, and other data. Developers access this information to improve the process performed by the system 500 as well as to improve offerings, such as design options available for the customized product.

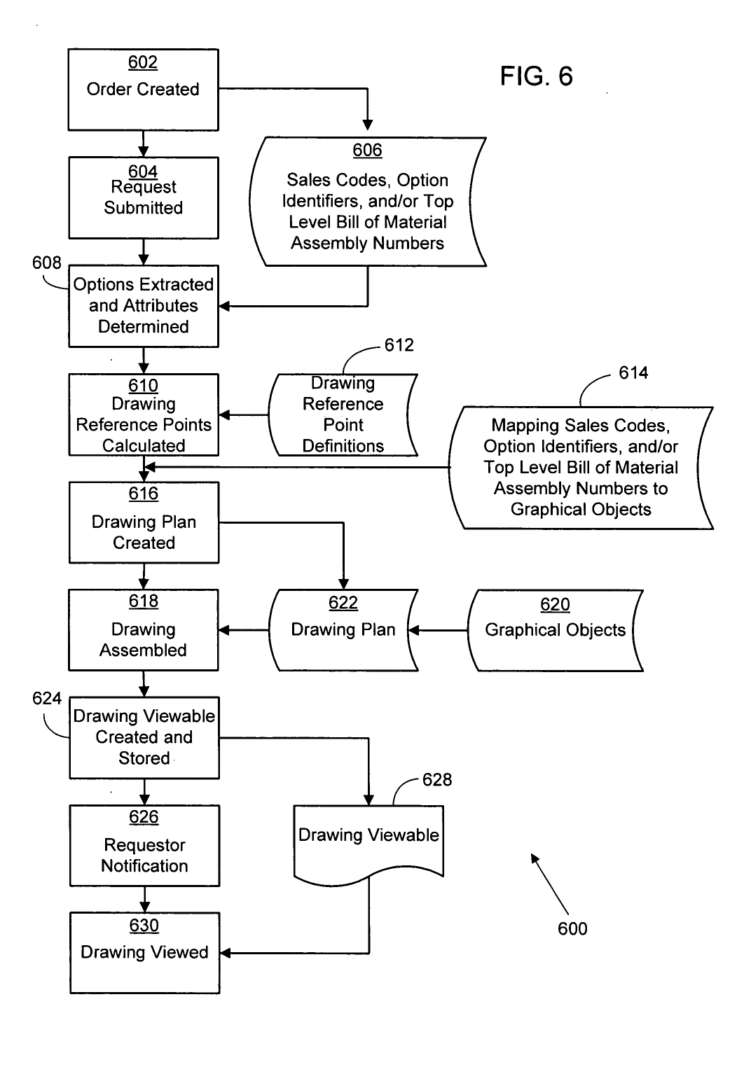

Referring now to FIG. 6, a block diagram of methods and systems for design of a customizable product is shown according to a possible embodiment of the present disclosure. In a possible embodiment, the system 600 operates within the architecture shown in FIG. 5 to create the proposed design drawing and generate the price quotation. In a possible embodiment, the system 600 operates within the server 306 in FIG. 3.

Preferably, the system 600 includes an order operation 602. The order operation 602 creates an order for a customized product. The order represents the preferences of a prospective purchaser of the customized product. In a possible embodiment, the order includes one or more design option selections, as represented by sales codes 606. Operational flow proceeds to a submission operation 604. The submission operation 604 submits the order created in the order operation 602. In a possible embodiment, the submission operation 604 corresponds to the dealer request operation 504 of FIG. 5.

Operational flow proceeds to an options operation 608. The options operation 608 extracts design options based on the sales codes 606 upon receipt of the request from the request operation 604. The design options selected in the order operation 602 correspond to sales options data 604. Upon receipt of a request from the submission operation 604, the options operation 608 determines the attributes of the customized product based on the design options selected, as represented by the sales codes 606. The options operation 608 loads one or more graphical objects corresponding to the sales codes 606.

Operational flow proceeds to a reference point operation 610. The reference point module calculates drawing reference points to form a design drawing of the overall customizable product. Design rules define the location of the drawing reference points. The reference point operation 610 uses reference point definitions 612 stored within the system 600, which indicate location, size, and other design constraints used by the system to create the proposed design drawing. For example, one or more reference point definitions 612 represent design rules for generating allowable locations for various types of graphical objects.

Sales code relations 614 map each of the possible stored sales codes to one or more drawing objects. The sales code relations 614 define the correspondence between the sales codes and graphical objects 620. In a possible embodiment, each sales code has a corresponding graphical object. In a further possible embodiment, one or more sale codes correspond to a single graphical object. In yet another possible embodiment, a sales code corresponds to more than one graphical object.

A drawing plan operation 616 receives the reference point definitions and the graphical objects as referenced by the sales codes, and compiles a drawing plan 622. The drawing plan 622 is a description of the layout of the graphical objects 620 formed by combining the reference point definitions with the graphical objects. The drawing plan operation 616 applies the reference point definitions to the graphical objects to assign locations in an overall design drawing to each object. Operational flow proceeds to a drawing operation 618 that compiles an overall design drawing. In one embodiment, the overall design drawing is a compiled AutoCAD drawing of the customizable product.

A viewable drawing operation 624 forms a viewable drawing from the assembled overall design drawing. The viewable drawing operation 624 converts the design drawing into a format understandable to a wide variety of computing systems, such as Adobe's Portable Document Format (PDF). A viewable drawing 628 is formed, and corresponds to the proposed design drawing described in FIG. 5. A notification operation 626 notifies a user of the system that the viewable drawing 628 is ready for viewing. In one embodiment, the notification operation 626 sends an electronic message to the user, who may be a prospective purchaser or a dealer of the customizable product. In a further embodiment, the notification module 626 sends the viewable drawing 628 to the user in the electronic message. A view operation 630 corresponds to the requester (e.g. a dealer or prospective purchaser) viewing the created proposed design drawing.

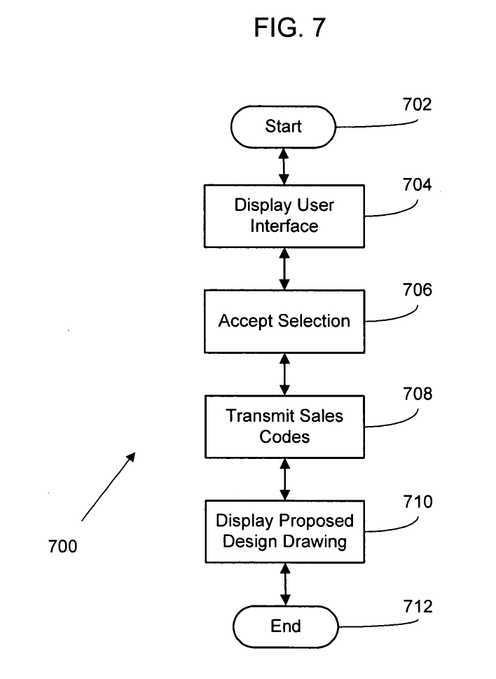

Referring now to FIG. 7, a block diagram of methods and systems for requesting a design of a customizable product is shown according to a possible embodiment of the present disclosure. The system 700 executes on a computing system, such as the computing system 304 of FIG. 3. A user interfaces with the system 700 to receive a proposed design drawing and an optional price quotation. Operational flow of the system 700 begins at a start operation 702. The start operation 702 corresponds to selecting and activating a user interface, such as a web portal. Operational flow proceeds to a display operation 704. The display operation 704 displays the user interface that includes a number of design options for design of a customizable product. The user can be a prospective purchaser, or can be a dealer of the customizable product. In one embodiment, the user interface is a web portal generated by a server. In another embodiment, the user interface is an application resident on a computing system such as the computing system 304 of FIG. 3 having shared data access with a server.

Operational flow proceeds to a selection operation 706. The selection operation 706 accepts one or more user selected design options. The selection operation 706 accepts selection of one or more design options shown in a user interface and presented by the display operation 704. The selection operation 706 compiles sales codes corresponding to the user selected design options.

Operational flow proceeds to a transmit operation 708. The transmit operation 708 transmits one or more sales codes from the computing system on which the user interface is displayed to a remote system. In one embodiment, the transmit operation 708 sends parameters, or sales codes, from a computing system 304 to a server 306 as shown in FIG. 3. In a second embodiment, the transmit module transmits data corresponding to the sales codes which are stored on the remote system. The data can be, for example, data related to the design options selected in the user interface. The server in turn generates the sales codes based on the data.

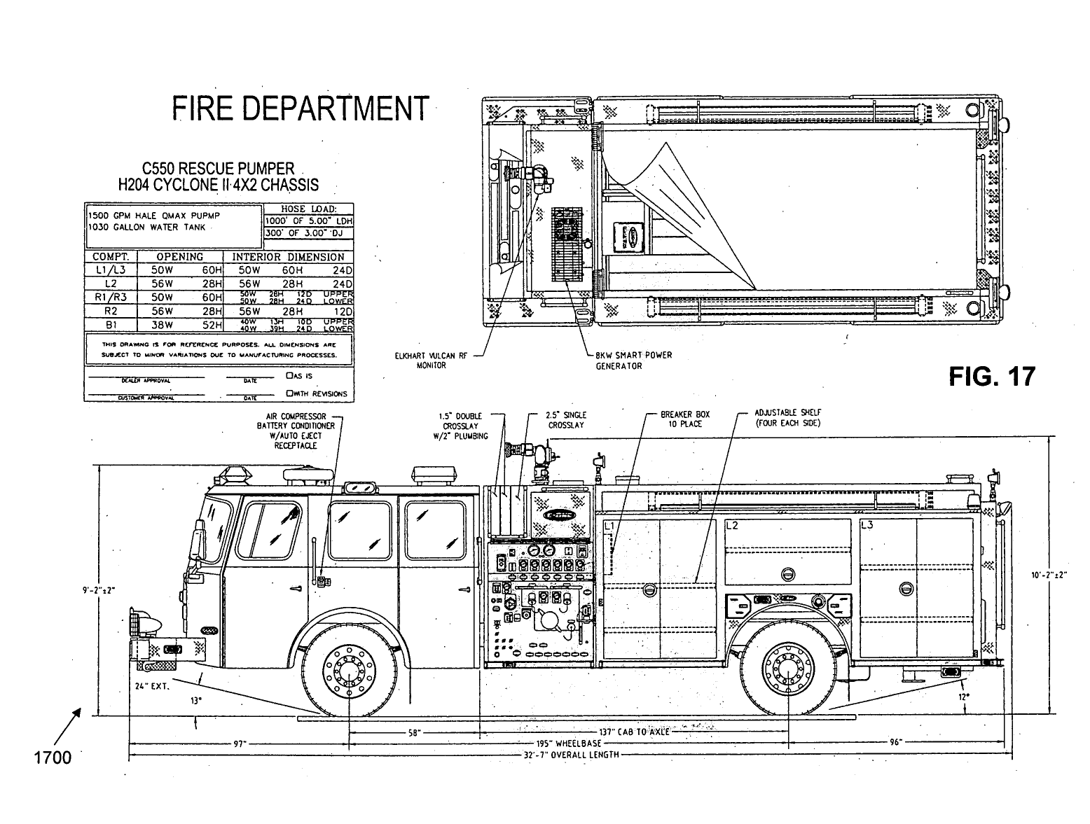

Operational flow proceeds to a display operation 710. The display operation 710 displays a proposed design drawing to the user of the system 700. The display operation 710 also optionally displays a price quotation alongside the proposed design drawing. An example proposed design drawing is shown in FIG. 17. The display operation 710 optionally receives the proposed design drawing from a remote system, such as the server 306 of FIG. 3.

Operational flow terminates at an end module 712.

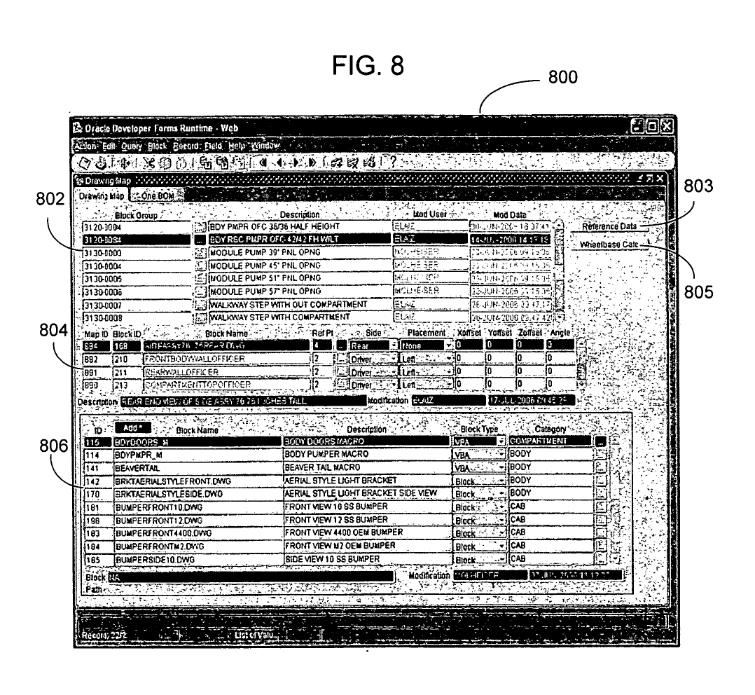

Referring now to FIGS. 8-14, an exemplary implementation of the systems and methods described herein are shown in the context of a request for proposed design drawing and price quotation process for a fire truck. FIGS. 8-14 present a number of user interface screens configured to either edit or display various sales codes, graphical objects, and design rules, according to one possible embodiment. The user interfaces illustrate the data objects used in the systems described above, and are presented to a designer such as an engineer. The designer can add or edit the sales codes, graphical objects, and design rules. For example, an editor or developer of the systems described herein may be granted both read and write access to the system. Preferably, one or more customer user interfaces are provided separate from the development user interface shown, such as the customer user interface shown below in FIGS. 15-16. In another embodiment, a fire truck dealer or prospective purchaser may only be presented with a read only version of the user interface shown in FIGS. 8-14 such that the dealer can select one or more of the options displayed, but cannot edit or change the graphical objects, design options, or sales codes. Although the following figures describe a user interface and implementation of the processes described above in conjunction with development and design of a fire truck, it is understood that the same systems and user interface features can be used in conjunction with other customizable products.

FIG. 8 shows an exemplary user interface 800 for design of a fire truck that associates sales codes to graphical objects and defines design rules according to a possible embodiment of the present disclosure. Preferably, the user interface 800 includes a drawing map that associates sales codes to graphical objects of the fire truck features. The drawing map can correspond to, for example, a particular model of fire truck that can be customized to order by a user. The user interface 800 corresponds to the drawing reference point definitions 612 of FIG. 6, and includes one or more block groups in a block group listing 802 with corresponding definitions 804. The block group listing 802 defines sales codes that correspond to graphical objects, also referred to as drawing blocks. The definitions 804 correlate the graphical objects to the one or more sales codes defined in the block group listing 802.

Related to each sales code defined in the block group listing 802 are one or more blocks as defined in a block listing 806. The block listing 806 corresponds to the entire listing of graphical objects available within the drawing block library 512 which can be associated to the sales codes in the block group listing via the definitions 804. In the user interface 800 shown, the block group selected, “BDY RDC PMPR OFC 42/42 FH W/LT” corresponds to a set of reference points and block names in the block listing related to that block group. A block change log 808 tracks changes made to the block group or in the blocks.

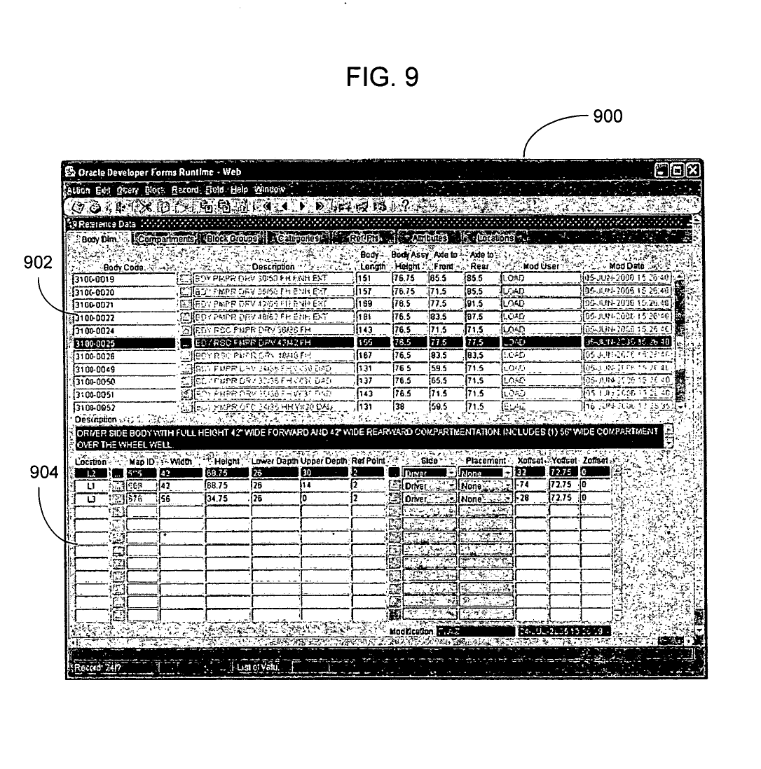

A reference data option 803 causes display of data related to the selected block group listing, such as the beginning height, width, or other parameters related to the particular fire truck model selected. Selection of the reference data option presents the screens described below in conjunction with FIGS. 9-13.

A wheelbase option 805 optionally calculates the wheelbase parameters for the selected block group, which again represents a particular fire truck model. In the context of a fire truck, the wheelbase may change based on one or more options selected by a customer, and the wheelbase length must be recalculated.

Referring to FIGS. 9-13, a series of user interface screens are presented upon selection of the reference data option 803. A user can navigate among the user interface screens by selecting the corresponding tab related to that user interface screen.

FIG. 9 shows an exemplary user interface 900 for design of a fire truck defining fire truck body graphical objects and design rules according to a possible embodiment of the present disclosure. The user interface 900 includes a body dimension listing 902 and a location listing 904.

The body dimension listing 902 defines the location of specific features which remain static in all fire truck designs, if selected by the user. The body dimension listing 902 includes a plurality of body entries, each body entry containing a body code, a description, a body length and height, axle lengths, and modification data. The body codes correspond to sales codes, and the body dimensions define a graphical object for a fire truck feature corresponding to the specific sales code. The description and modification information assist a user of the user interface 900 to determine the type and intended use for the body dimension selected.

The location listing 904 defines one or more location entries related to each body entry for which specific features can be located. For example, the body dimension shown as selected in FIG. 9 has three location entries defined, L1, L2, and L3, which correspond to locations for possible features to be added to the fire truck. Each location entry also includes dimension data, including height, width, and depth data, as well as placement information along a three dimensional coordinate system.

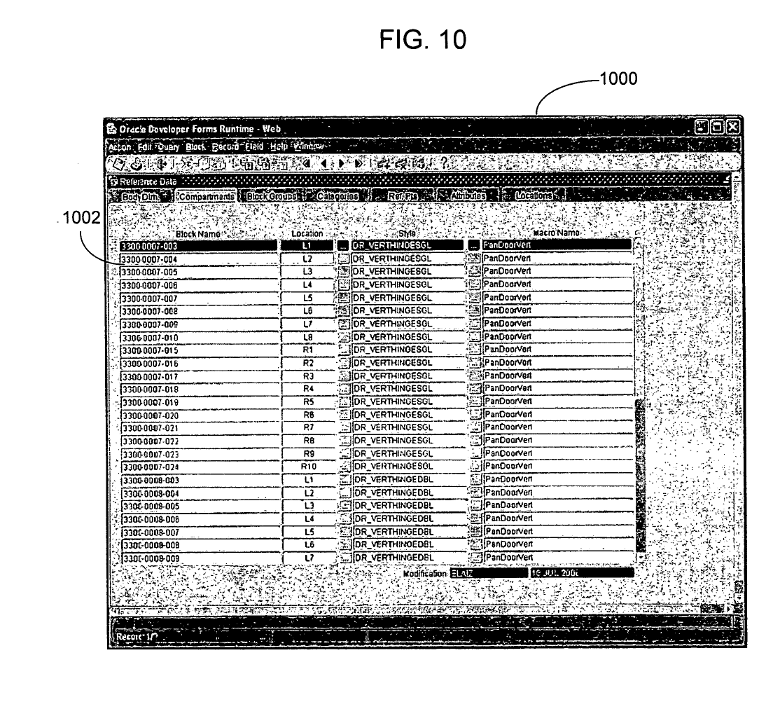

Referring now to FIG. 10, an exemplary user interface 1000 for design of a fire truck is shown defining fire truck compartment graphical objects and design rules according to a possible embodiment of the present disclosure. The user interface 1000 generally defines what graphical objects are incorporated into the proposed design drawing and how the drawing is assembled. The user interface 1000 includes a graphical object listing, shown as a compartment listing 1002. The compartment listing 1002 defines sales codes and associated location codes defined in the location listing 904. The compartment listing 1002 includes a block name entry, a location, a style, and a macro name, and defines the drawing block associated with each sales code and location code. The block names again correspond to sales codes for the specific compartment design option. The location corresponds to possible locations at which the feature can be located on the fire truck. For example, the first compartment entry in the compartment listing is locatable at location L1, which was previously defined in user interface 900. The macro name entry lists a macro to be executed by the software upon selection of the specific option. A macro refers to a function or group of functions that automate tasks typically performed using a user interface. For example, a view changing macro “PanDoorVert” is performed upon user selection of any of the blocks shown in the block listing and would also affect the view of the graphical object or proposed design drawing in a user interface, for example in a drafting program such as AutoCAD. Other macro name entries and associated macro operations are possible as well.

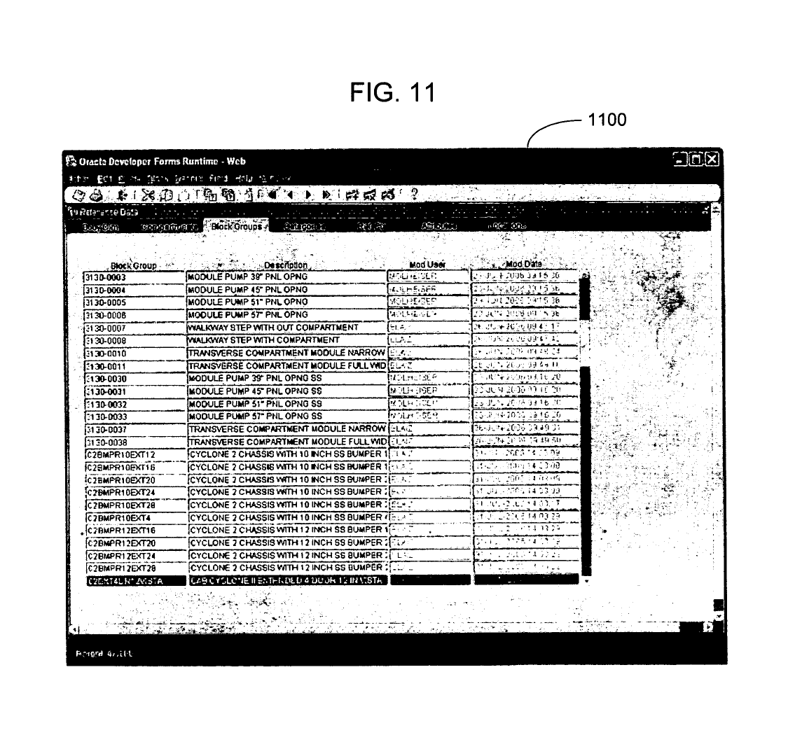

FIG. 11 shows an exemplary user interface 1100 for design of a fire truck defining groupings of fire truck graphical objects according to a possible embodiment of the present disclosure. The groupings of fire truck graphical objects, also referred to as block groups, are combinations of graphical objects configured to form a modular subsection of an overall design of the fire truck. In a possible embodiment, the block groups define all of the possible block groups of FIG. 8. For example, the block groups can be sales codes and their descriptions or sales code combination values and their descriptions. The block groups include a block group code, a description, and modification information. The block group code corresponds to a sales code related to the block group, which can be a grouping of design options for the fire truck. The description information corresponds to the descriptions 804 of FIG. 8. The modification information corresponds to the block change log 808 of FIG. 8 as well.

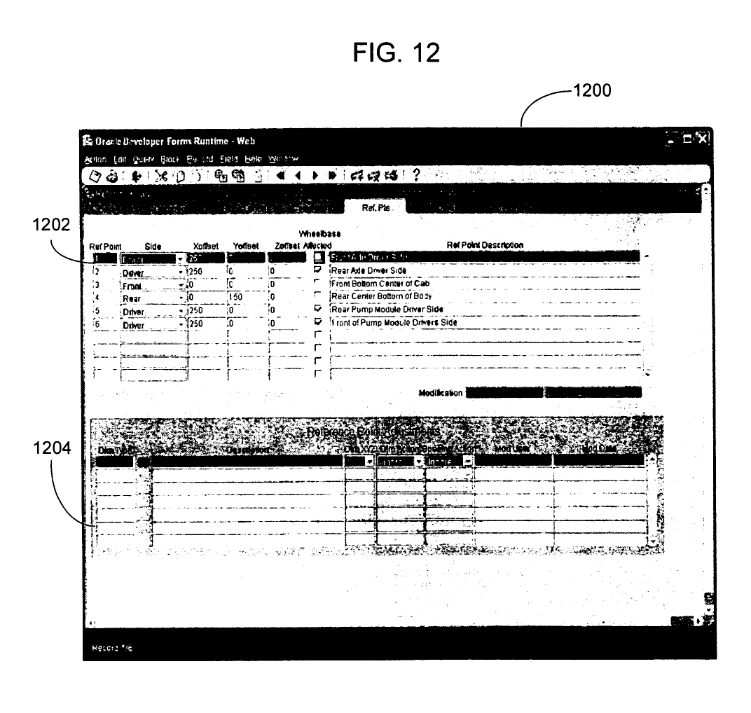

FIG. 12 shows an exemplary user interface 1200 for design of a fire truck defining reference point design rules according to a possible embodiment of the present disclosure. Reference points refer to locations on a proposed design drawing used to locate additional features of a customizable product. In the case of the fire truck, the reference points are located on various sides of the truck and affect location of features such as wheelbase length and other added features. In a possible embodiment, the user interface provides user access to the reference point definitions 612 of FIG. 6.

The user interface 1200 includes a reference point listing 1202 and an adjustments listing 1204. The reference point listing 1202 defines default reference point positions on the drawing used to locate drawing blocks. Since some of the reference points move depending on ordered features, the reference points are generally calculated for each order. The reference point listing 1202 includes a reference point index number, a side identifier, location coordinates, a wheelbase modifier, and description. The reference index number distinguishes the reference points, in that a different reference index number is provided for each reference point. The side identifier indicates the side of the fire truck on which the reference point is located. The location coordinates define the location in three-dimensional space at which the reference point is located. The wheelbase modifier indicates whether or not the wheelbase length of the fire truck is affected by the specific reference point. The reference point description provides a user-understandable description of the location of the reference point.

The adjustments listing 1204 includes one or more adjustment entries, which list the adjustments to be used with one or more of the reference points. The adjustments listing 1204 defines order specific adjustments to the movable reference points as indicated in 1202. If a feature is found on the order that impacts one of the reference points, that dimension is adjusted accordingly. The adjustments listing 1204 includes a dimension type field, a description field, a dimension field, a dimension action field, a spacing action field, and modification information fields. The dimension type field lists the type of dimension affected by user of a selected reference point. The description field provides a user-understandable description of the effect of applying the adjustment entry to a design drawing. The dimension field selects one of the three dimensions in a Cartesian coordinate system for modification. The dimension action field describes the action to be taken in the dimension selected in the dimension field, such as adjusting the location of one or more graphical objects. The spacing action field describes changes in spacing of graphical objects affected by the adjustment. The modification information fields track the history of changes to the adjustment entry in the adjustments listing 1204.

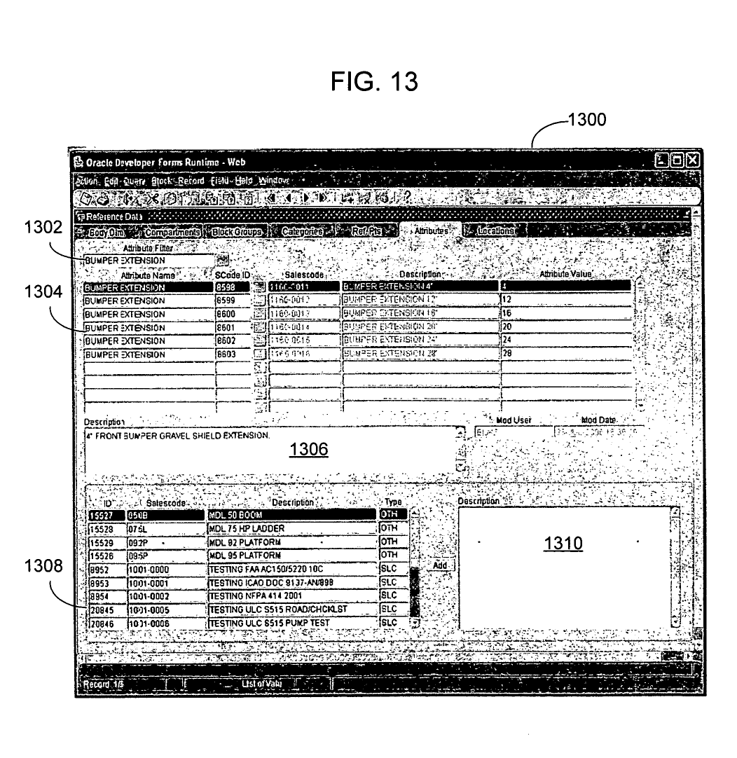

FIG. 13 shows an exemplary user interface 1300 for design of a fire truck defining attributes of graphical objects according to a possible embodiment of the present disclosure. The user interface 1300 allows a user to assign or select attributes associated with one or more sales codes. The user interface 1300 also corresponds to the sales code relations 614 of FIG. 6, in that it displays graphical objects and their association to sales codes.

The user interface 1300 includes an attribute filter field 1302, an attribute listing 1304, an attribute description field 1306, a graphical object listing 1308, and a graphical object description field 1310. The attribute filter field 1302 allows a user to search for a specific attribute, representing a graphical object stored in the design database 507 of FIG. 5. The search results display in the attribute listing 1304. The attribute listing 1304 defines attributes and their values. The attribute listing 1304 assigns sales codes to attributes so that if that sales code is found on the order, the value of the associated attribute is stored. These attribute values are used by the automatic drawing module 506 of FIG. 5.

Each attribute entry in the attribute listing 1304 includes an attribute name, a sales code identifier, a sales code, a description, and an attribute value. The attribute name corresponds to the field searched using the attribute filter field. The sales code identifier corresponds the attribute to one or more sales codes, in that each attribute has an identifier used in conjunction with the sales code to assign that attribute to a graphical object. The sales code corresponds to one or more graphical objects, for which the attribute is also associated. A description field provides a text description of the attribute entry, and the attribute value represents a numerical differentiator between the various attributes. In the example shown, a bumper extension can be incorporated into the fire truck, and a developer enters one of six different length bumper extensions. In the embodiment shown, the four inch bumper extension is selected. The attribute description field 1306 provides an extended description of the selected attribute entry in the attribute listing 1304. In the embodiment shown, the description of the bumper extension is shown as “4″ FRONT BUMPER GRAVEL SHIELD EXTENSION”.

The graphical object listing 1308 includes one or more graphical object entries for corresponding sales codes to graphical object descriptions, and provides a list of all available sales codes that are defined in the system. The graphical object description field 1310 displays an extended text description of the graphical object in the graphical object listing 1308. By pressing the “Add” button, a selected sales code is assigned to the attribute.

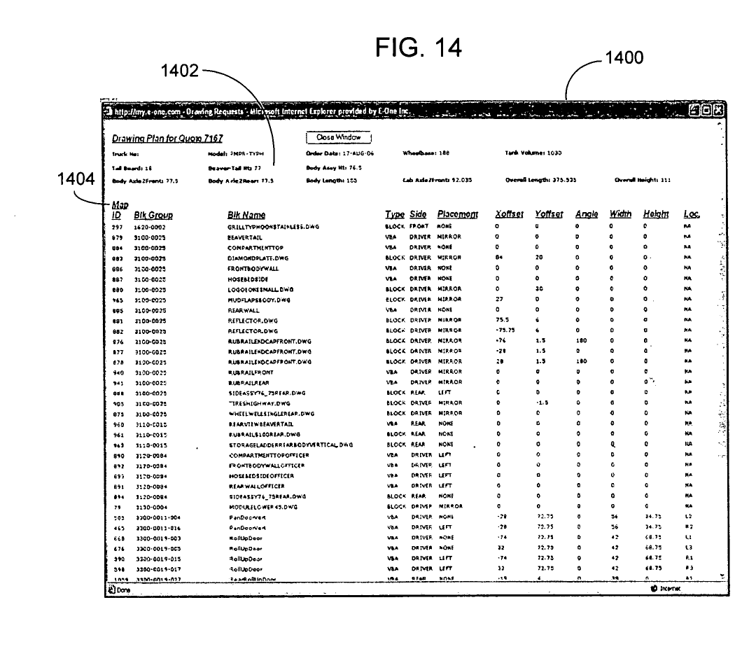

FIG. 14 shows an exemplary user interface 1400 for design of a fire truck displaying an overall drawing plan according to a possible embodiment of the present disclosure. In general, the user interface 1400 displays all of the selected design options and default design options necessary to form the proposed design drawing of the fire truck. The user interface 1400 includes overall proposed design data 1402 as well as a design object listing 1404. The overall proposed design data 1402 displays attributes of the designed fire truck based on the selected design options, and includes, for example, the truck model, wheelbase, water tank volume, axle dimensions, and overall dimensions. The user interface 1400 optionally displays a price quotation as well.

The design object listing 1404 displays each selected graphical object used in the proposed design drawing, and briefly describes the location and use of each graphical object. The information displayed in the design object listing 1404 includes the drawing block name, the type of graphical object, the side of the fire truck to which the object applies, and the placement of the graphical object in the proposed design drawing.

FIG. 15 shows an exemplary customer, or end-user, interface 1500, or portal, for receiving a request for a proposed design according to a possible embodiment of the present disclosure. In general, the user interface 1500 allows the dealer or customer to configure his quotation, manage his finances, attach files, and workflow the quotation to other groups. The user interface 1500 is selected using a set of navigation tabs 1502. The user interface 1500 includes a number of regions configured to accept information from a user necessary to generate a proposed design drawing and price quotation. The user interface 1500 includes a quotation region 1504, a unit region 1506, a customer region 1508, a time region 1510, and an actions region 1512. More or fewer regions are possibly implemented in the user interface 1500 as well.

The quotation region 1504 accepts input information related to the price quotation requested, such as the number of units requested, the type of quote requested, the type of products requested, and other information. Optionally, the quotation region 1504 can display the status of previously requested quotes as well. For example, the drawing status can be displayed, and the user interface 1500 can indicate the status of the request—Submitted, Working, Requested, Processing, or Complete. The quotation region 1504 includes a “Request Drawing” link with which a dealer can request a drawing of his configured quote.

The remaining regions provide additional information regarding the product and customer. The unit region 1506 displays the model and specifications of the fire truck requested by the customer. The customer region 1508 displays customer identification information, such as the customer identification number and a company name. The time region 1510 displays a forecasted order fulfillment date, a requested date, and other options. The actions region 1512 allow a user to select, copy, and navigate within one or more quotation screens and share data between applications and/or portal screens.

FIG. 16 shows an exemplary customer user interface 1600 for viewing and downloading a proposed design drawing according to a possible embodiment of the present disclosure. The user interface 1600 generally allows a dealer to view and/or download the completed automated drawings from the server 306 of FIG. 3. The user interface 1600 is selected using the set of navigation tabs 1502. The user interface 1600 includes a design listing 1602 containing a list of available proposed design drawings. The portal user views the drawings by pressing either “Page 1” or “Page 2” depending on the views he desires. A timestamp is also displayed in the design listing 1602 indicating the date of the drawing.

FIG. 17 is an example proposed design drawing 1700 of a fire truck generated according to the principles of the present disclosure. The proposed design drawing 1700 can be a drawing available in the design listing 1602 of FIG. 16, and reflects the graphical objects referenced using the sales codes derived from the design option selection process described herein. The drawing could include more or less detail as desired. The proposed design drawing 1700 optionally includes dimension information as well. The proposed design drawing 1700 also optionally includes a price quotation. In the embodiment shown, the proposed design drawing 1700 includes a side view and a top view of the fire truck. Alternate views of the fire truck can be generated, such as a front or rear view. The proposed design drawing can be provided to a user as a PDF document, an AutoCAD file, or other user-understandable file format. In an alternate embodiment, the proposed design drawing is provided to the user in a print format.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A computer implemented method of designing a customizable product comprising:
receiving at least one parameter associated with the customizable product;
selecting at least one graphical object associated with the at least one parameter; and
applying at least one design rule to the at least one graphical object to generate a design drawing.

2. The method of claim 1, further comprising generating a price quotation related to the design drawing.

3. The method of claim 1, wherein receiving includes receiving at least one sales code associated with the customizable product.

4. The method of claim 1, further comprising associating a plurality of design options of the customizable product with a plurality of sales codes.

5. The method of claim 1, further comprising generating a user interface displaying a plurality of design options related to the at least one parameter.

6. The method of claim 5, wherein receiving comprises accepting user input selecting one or more design options associated with at least one parameter.

7. The method of claim 1, further comprising transmitting the proposed design drawing to a remote computer.

8. The method of claim 1, further comprising allowing the proposed design drawing to be viewable to a prospective purchaser of the customizable product.

9. A computerized system for design of customizable products, the system comprising:
a memory configured to store a plurality of parameters and a plurality of graphical objects associated with the plurality of parameters;
a programmable circuit configured to:
associate a plurality of graphical objects with the plurality of parameters;
receive one or more parameters;
select one or more graphical objects associated with the one or more parameters;
apply one or more design rules to the one or more graphical objects to generate a proposed design drawing.

10. The computerized system of claim 9, wherein the programmable circuit is further configured to generate a price quotation.

11. The computerized system of claim 9, wherein the programmable circuit is further configured to present a user interface for displaying a plurality of design options related to the customizable product.

12. The computerized system of claim 9, wherein the design options correspond to the one or more sales codes.

13. The computerized system of claim 9, wherein the programmable circuit is further configured to transmit the proposed design drawing to a client computer.

14. The computerized system of claim 13, wherein the programmable circuit is further configured to selectively allow the proposed design drawing to be viewable to a prospective purchaser of the customizable product.

15. A method of requesting a design of a customizable product, the method comprising:
displaying a user interface presenting a plurality of sales options associated with a plurality of sales codes;
accepting user selection of one or more sales options from the plurality of sales options;
transmitting one or more sales codes associated with the one or more sales options; and
displaying a proposed design drawing of the customizable product, the drawing incorporating one or more graphical objects associated with the one or more sales codes;
wherein one or more design rules applied to the graphical objects form the proposed design drawing.

16. A method of designing a fire truck comprising:
receiving sales codes related to design options for the fire truck;
selecting graphical objects associated with the sales codes;
applying design rules to the graphical objects to generate a proposed design of the fire truck;
validating the proposed design; and
displaying the proposed design.

17. The method according to claim 16, wherein receiving sales codes related to design options for the fire truck through a user interface on a remote computing system.

18. The method according to claim 17, wherein selecting graphical objects includes selecting graphical objects associated with the sales codes in a database.

19. The method according to claim 18, wherein applying design rules includes applying design rules to the graphical objects in a database to generate a proposed design of the fire truck.

20. The method according to claim 19, wherein displaying the proposed design includes displaying the proposed design through the user interface.
